(19) United States
(12) Patent Application Publication
(10) Pub. No.: US 2004/0234331 A1
(43) Pub. Date: Nov. 25, 2004

(54) Fastener construction

(76) Inventor: Robert Fenton, Las Vegas, NV (US)

Correspondence Address: POWELL, GOLDSTEIN, FRAZER & MURPHY LLP, P.O. Box 97223, Washington, DC, 20090-7223, US

(21) Appl. No.: 10/443,715

(22) Filed: May 23, 2003

(51) Int. Cl. B43M 15/00

(52) U.S. Cl. 403/286; 411/439

(57) ABSTRACT

A fastening system includes a substantially flat body and at least one fastening pin extending therefrom. In its preferred embodiment, the fastening system includes a pair of opposed and axially-aligned pins, each of the pins extending from each side of the substantially flat body. In an alternate embodiment the fastening system includes an adhesive provided on one side of the substantially flat body and a fastening pin extending from the other side of the body. In either embodiment the substantially flat body is preferably disc-shaped, although the shape of the body may be adapted as needed.

### TECHNICAL FIELD

The present invention relates generally to fasteners that may find use in coupling or fastening two parts together. More particularly, in its preferred embodiment the present invention relates to a double-ended fastener that comprises a substantially flat body and two opposed and axially-aligned fastening pins.

### DISCUSSION

A broad variety of fasteners have been created for an equally broad variety of purposes. Chief among these fasteners are the mechanical fasteners. These include fasteners of the snap variety, the clasp variety, and the frictional engagement variety, the latter including pins, prongs and nails.

There are several examples of the frictional engagement fasteners known in the art. Some of these examples follow.

U.S. Pat. Nos. 3,693,496, 2,230,392, 5,669,912, and 5,743,693 all relate to frictional fasteners. Depending on their intended uses, the pins may have prongs (U.S. Pat. No. 2,230,392) or the fastener has a plurality of support members secured to the central flange for preventing movement of the center flange during driving of the double-ended nail into wood (for example, U.S. Pat. No. 5,743,693).

U.S. Pat. No. 4,779,393, which is directed to building methods and structures, relates to double-ended nails.

U.S. Pat. Nos. 346,148 and 2,570,626 relate to double-ended nails having different parts for each side, for example, a pin at one side and screw at the other side.

U.S. Pat. No. 5,159,116 relates to a mounting fixture which has a pressure sensitive adhesive on its plate part rendering it be attached to the wall or ceiling. U.S. Pat. No. 4,324,074 relates to a hanger member having a planar base plate and a hanger rod. The hanger member may be used in building structure wherein the hanger member is secured to an insulating foam layer that is applied onto an inflated form. Both patents disclose that the fasteners have an adhesive material on their head or planar base plate.

U.S. Pat. Nos. 4,223,585 and 3,897,713 relate to double-ended stud-type fasteners. In particular, U.S. Pat. No. 3,897,713 shows a double-ended type fastener, one extremity of which is provided with sharp crested peripheral protuberances and which carries a volume of heat activated adhesive.

While providing improvements in the art of mechanical fasteners, the known art still fails to provide an efficient, cost-effective method for fastening to articles together.

### SUMMARY OF THE INVENTION

The present invention provides a fastening system applicable for use in fastening two articles.

Accordingly, it is an object of the present invention to provide a fastening system that includes a substantially plat body and at least one fastening pin extending therefrom.

A further object of the present invention is to provide such a system that is relatively easy to manufacture and package.

An additional object of the present invention is to provide such a system that can be formed from either a metal or a plastic.

Still a further object of the present invention is to provide such a system that is relatively easy to use.

Yet another object of the present invention is to provide such a system that may be used for a broad variety of fastening applications.

These and other objects of the present invention are achieved by a fastening system that includes a substantially flat body and at least one fastening pin extending therefrom. In its preferred embodiment, the present invention includes a pair of opposed and axially-aligned pins, each of the pins extending from each side of the substantially flat body. In an alternate embodiment the present invention includes an adhesive provided on one side of the substantially flat body and a fastening pin extending from the other side of the body. In either embodiment the substantially flat body is preferably disc-shaped, although the shape of the body may be adapted as needed.

Many features, advantages, and objects of the present invention will become apparent to one with skill in the art upon examination of the drawings and detailed description that follows. It is intended that all such features, advantages, and objects be included herein within the scope of the present invention.

### BRIEF DESCRIPTION OF THE DRAWINGS

The present invention will be more fully understood by reference to the following detailed description of the preferred embodiments of the present invention when read in conjunction with the accompanying drawings, in which like reference characters refer to like parts throughout the views, and in which:

FIG. 1 is perspective view illustrating the first preferred embodiment of the present invention;

FIG. 2 is a sectional side view illustrating the first preferred embodiment in its fastening position between two articles;

FIG. 3 is a perspective view illustrating the second preferred embodiment of the present invention; and

FIG. 4 is a sectional side view illustrating the second preferred embodiment in its fastening position between two articles.

### DETAILED DESCRIPTION OF THE PREFERRED EMBODIMENTS

The drawings disclose the preferred embodiments of the present invention. While the configurations according to the illustrated embodiment are preferred, it is envisioned that alternate configurations of the present invention may be adopted without deviating from the invention as portrayed. The preferred embodiments are discussed hereafter.

First Preferred Embodiment

With respect first to FIG. 1, this figure illustrates a perspective view of the first preferred embodiment of the present invention, generally illustrated as fastener 10. The fastener 10 includes a substantially planar body 12, a first fastening pin 14, and a second fastening pin 16. As illustrated, the pins 14, 16 are axially aligned and their long axes are perpendicular to the plane of the planar body 12.

The planar body 12 is illustrated as being a disk. This is only intended as being illustrative as other configurations, such as a square shape, an oval shape, or a rectangular shape, are envisioned as being appropriate for the present invention.

The planar body 12 may be of a variety of widths. Examples of preferred widths (used for illustrative purposes only; actual fasteners according to the present invention may have different dimensions) are ¼″, ½″, and ¾″, these sizes being preferred for conventional home use.

The lengths of the pins 14, 16 may be equal, or may be different. However, their preferred lengths are 1/16″ for a ¼″ wide planar body 12, 3/16″ for a ½″ planar body 12, and ¼″ for a ¾″ wide planar body 12. Yet in any event it is preferred that the length of each of the pins 14, 16 is shorter than the width of the planar body 12. This configuration renders superior structural integrity to the pin 10 and provides better stability for the fastened articles relative to one another.

The planar body 12 and the pins 14, 16 may be made of the same material or may be made of different materials, including a metal (such as the preferred metal, brass) or a polymerized material (such as the preferred polymerized material, a substantially rigid plastic). If made of the same material, the planar body 12 and the pins 14, 16 may be cast as a single part. If made from different materials (for example, the planar body 12 being composed of a polymerized material and the pins 14, 16 being composed of a brass material), then the elements are formed separately and are fastened together according to known techniques.

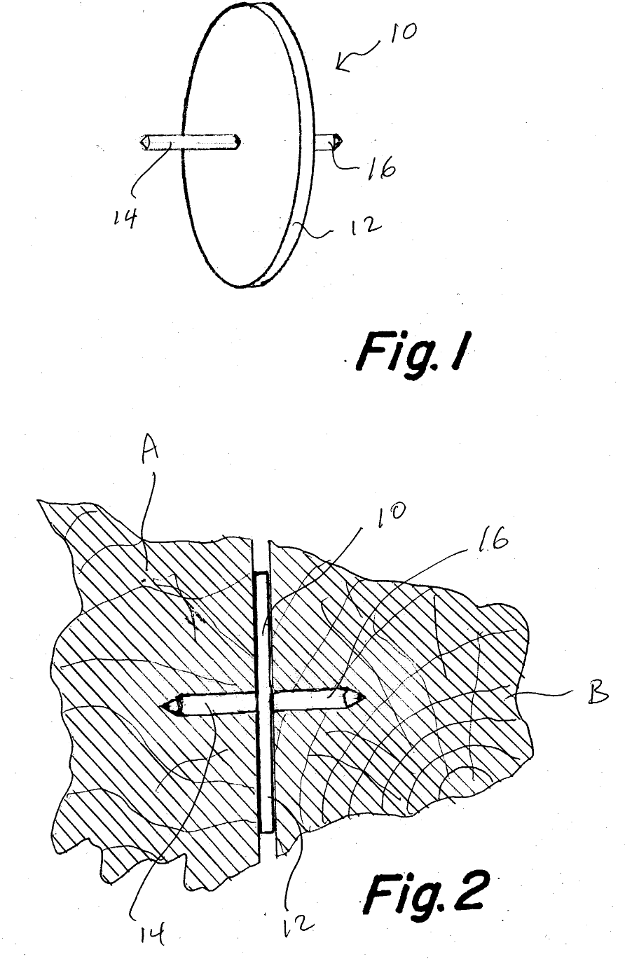

Referring to FIG. 2, the fastener 10 according to the first preferred embodiment is illustrated holding two articles together, article A and article B. The articles A, B are shown as being composed of a wood. However, it is to be understood that the present invention may be used for holding together a wide variety of articles, including articles composed of plastic, cement, and plasterboard, for example. In addition, the articles A, B need not be of like materials, but can be of different materials.

Second Preferred Embodiment

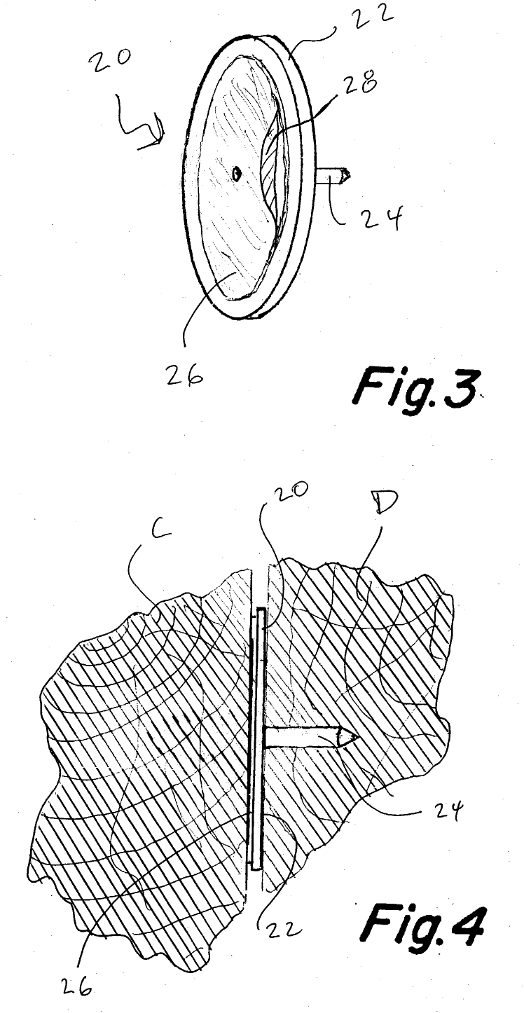

FIG. 3 is a perspective view illustrating the second preferred embodiment of the present invention, generally illustrated as fastener 20. Similar in design and function to the fastener 10, the fastener 20 includes a substantially planar body 22, a fastening pin 24, and an adhesive 26. The long axis of the pin 24 is perpendicular to the plane of the planar body 22.

Again, like the planar body 12, the planar body 22 is illustrated as being a disk. This is only intended as being illustrative as other configurations, such as a square shape, an oval shape, or a rectangular shape, are envisioned as being appropriate for the present invention.

The generally preferred dimensions of the planar body 22 are the same as those of the planar body 12. The selected materials of the planar body 22 and the pin 24 are the same as those set forth above with respect to the planar body 12 and the pins 14, 16 of fastener 10.

The fastener 20 includes the adhesive 26. A protective release paper 28 is optionally but preferably provided over the adhesive 26 to protect it before application. The adhesive 26 may be any one of a variety of high-strength, long-duration adhesives known to those skilled in the art. The adhesive 26 may also be of the heat-activated variety, thus possibly eliminating the need for the release paper 28.

In use, where the protective release paper 28 is used, the paper 28 would be removed prior to application to a surface to be fixed. If the adhesive 26 is heat-activated, the adhesive 26 would be exposed to a source of heat prior to application.

The fastener 20 is shown in use in FIG. 4. A pair of attached articles C, D is shown being attached by the fastener 20. The composition of the articles C, D is illustrated as being of a wood, but these materials can be like or can be different and can be other than wood.

As illustrated, the adhesive 26 of the fastener 20 is shown attached to article C. The fastener 20 is mechanically attached to article D by the pin 24.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and following claims. All such modifications and variations are intended to be within the scope of the present invention.

What is claimed is:

1. A fastening system, the system having a substantially flat body, said body having a first side and a second side, the system further including a first fastening pin and a second fastening pin, said first pin extending from said first side of said body and said second pin extending from said second side of said body, said first and second pins being axially-aligned, said body having a width and a thickness and wherein said first pin has a length and said second pin has a length, said width of said body being greater than said length of said first pin and said length of said second pin.

2. A fastening system, the system having a substantially flat body, said body having a first side and a second side, the system further including a first fastening pin and a second fastening pin, said first pin extending from said first side of said body and said second pin extending from said second side of said body.

3. The fastening system of claim 2 in which said first and second pins are axially-aligned.

4. The fastening system of claim 3, wherein said body has a width and a thickness and wherein said first pin has a length and said second pin has a length, said width of said body being greater than said length of said first pin and said length of said second pin.

5. The fastening system of claim 4, wherein said body and said first and second pins are produced from the same material.

6. The fastening system of claim 5, wherein said material is a metal.

7. The fastening system of claim 5, wherein said material is a polymerized material.

8. The fastening system of claim 4, wherein said body is produced from a first material and said first and second pins are produced from a second material, said first material being different from said second material.

9. The fastening system of claim 8, wherein said first material is selected from the group consisting of a metal and a plastic and said second material is selected from a group consisting of a plastic and a metal.

10. The fastening system of claim 2, wherein said first pin has a length and said second pin has a length, said lengths being substantially the same.

11. The fastening system of claim 2, wherein said first pin has a length and said second pin has a length, said lengths being substantially different.

12. A fastening system, the system having a substantially flat body, said body having a first side and a second side, the system further including a fastening pin and an adhesive, said fastening pin extending from said first side of said body and said adhesive being applied to said second side of said body.

13. The fastening system of claim 12, in which said body has a center, said pin extending substantially from said center of said body.

14. The fastening system of claim 12, wherein said body has a width and a thickness and wherein said pin has a length, said width of said body being greater than said length of said pin.

15. The fastening system of claim 12, wherein said body and said pin are produced from the same material.

16. The fastening system of claim 15, wherein said material is a metal.

17. The fastening system of claim 15, wherein said material is a polymerized material.

18. The fastening system of claim 11, wherein said body is produced from a first material and said pin is produced from a second material, said first material being different from said second material.

19. The fastening system of claim 17, wherein said first material is selected from the group consisting of a metal and a plastic and said second material is selected from a group consisting of a plastic and a metal.

20. The fastening system of claim 11, wherein said adhesive may be heat-activated.

21. The fastening system of claim 11, further including a protective, removable release paper fitted over said adhesive.
